(19) United States
(12) Patent Application Publication
(10) Pub. No.: US 2020/0118178 A1
(43) Pub. Date: Apr. 16, 2020

(54) METHODS FOR RECORDING CHARITABLE ACTIVITIES

(71) Applicant: Raymond Smithberger, Avon, CT (US)

(72) Inventor: Raymond Smithberger, Avon, CT (US)

(21) Appl. No.: 16/596,161

(22) Filed: Oct. 8, 2019

Related U.S. Application Data
(60) Provisional application No. 62/743,759, filed on Oct. 10, 2018.

(51) Int. Cl. G06Q 30/02; G06F 16/28

(52) U.S. Cl. CPC G06Q 30/0279; G06F 16/288

(57) ABSTRACT

Methods, computer programs and computer systems for performing the methods. The method includes obtaining an aggregated contribution score and charitable contribution information and applying a weighing factor to the charitable contribution information to determine a weighted score. The weighted score is added to the aggregated contribution score to update that score. The updated aggregated contribution score is added to at least another aggregated contribution score to determine a charitable activity score. Other charitable activity scores are combined with the first charitable activity score to determine a charitable campaign activity score, and the charitable activity score and charitable campaign activity score are displayed in an interface.

### CROSS-REFERENCE TO RELATED APPLICATION

This application is related to U.S. Provisional Patent Application Ser. No. 62/743,759, filed Oct. 10, 2018, entitled “METHODS FOR CREATING AND UPDATING CHARITABLE ACTIVITY PROFILES” and is hereby incorporated by reference.

### FIELD OF THE INVENTION

The present invention relates to charitable donations and campaigns, and more specifically to methods and computer programs and computer systems for recording and tracking charitable activities and donations to charitable campaigns and promoting the same.

### BACKGROUND

Charitable giving and activities are traditionally viewed as desirable social objectives, both for individuals as well as for businesses and organizations. Motivating individuals to contribute their time and money to charitable campaigns remains a challenge, and many businesses, particularly small businesses, struggle to maximize the benefits they derive from organizing charitable campaigns. Improved processes for organizing charitable campaigns and recording and tracking charitable donations are needed.

### SUMMARY

In an embodiment, a method is disclosed that includes: obtaining charitable contribution information; applying a weighting factor to the charitable contribution information to calculate a weighted score; adding the weighted score to the first aggregated contribution score to determine an updated first aggregated contribution score; obtaining at least one second aggregated contribution score; combining the updated first aggregated contribution score and the at least one second aggregated contribution score to determine a first charitable activity score; obtaining at least one second charitable activity score; combining the first charitable activity score and the at least one second charitable activity score to determine a charitable campaign activity score; and, displaying, in a graphical user interface, the first charitable activity score and the charitable campaign activity score.

In an embodiment, a computer program is disclosed. The computer program comprises program code to perform a method for generating and updating a charitable activity profile, the method including: obtaining charitable contribution information; applying a weighting factor to the charitable contribution information to calculate a weighted score; adding the weighted score to the first aggregated contribution score to determine an updated first aggregated contribution score; obtaining at least one second aggregated contribution score; combining the updated first aggregated contribution score and the at least one second aggregated contribution score to determine a first charitable activity score; obtaining at least one second charitable activity score; combining the first charitable activity score and the at least one second charitable activity score to determine a charitable campaign activity score; and, displaying, in a graphical user interface, the first charitable activity score and the charitable campaign activity score.

In another embodiment, a computer system is disclosed. The computer system includes: a memory; one or more processors operatively coupled with the memory; a computer readable storage medium; and, one or more computer program comprising program code stored on the computer readable storage medium and executable by the one or more processors via the memory to perform a method for generating and updating a charitable activity profile, the method including: obtaining charitable contribution information; applying a weighting factor to the charitable contribution information to calculate a weighted score; adding the weighted score to the first aggregated contribution score to determine an updated first aggregated contribution score; obtaining at least one second aggregated contribution score; combining the updated first aggregated contribution score and the at least one second aggregated contribution score to determine a first charitable activity score; obtaining at least one second charitable activity score; combining the first charitable activity score and the at least one second charitable activity score to determine a charitable campaign activity score; and, displaying, in a graphical user interface, the first charitable activity score and the charitable campaign activity score.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a flow diagram of a computer program configured to execute one or more processes in accordance with embodiments of the invention.

FIG. 2 is a flow diagram of a computer program configured to execute one or more processes in accordance with embodiments of the invention

FIG. 3 is an exemplary schematic of a computer system including a computer program configured to execute one or more processes in accordance with embodiments of the invention.

### DETAILED DESCRIPTION

Aspects of the present disclosure and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the disclosure in detail. It should be understood, however, that the detailed description and the specific examples, while indicating aspects described herein, are given by way of illustration only, and not by way of limitation. Various substitutions, modifications, additions, and/or arrangements, within the spirit and/or scope of the underlying concepts will be apparent to those skilled in the art from this disclosure.

Charitable giving and activities are traditionally viewed as desirable social objectives, both for individuals as well as for businesses and organizations. Businesses frequently organize charitable campaigns to help a cause or charitable organization, and will often encourage their employees to contribute their time, money, goods, and other types of donations to further a charitable campaign. In many cases, it can be difficult to motivate individuals to contribute to charitable campaigns. It may be difficult for individuals to see what impact their donations have on a campaign, or to understand how to donate so they have the most impact on a campaign. Businesses, and in particular small businesses, frequently engage in charitable campaigns to help their communities and cities and look to charitable campaigns to build good will and reputations within their communities. Yet businesses often struggle to maximize the benefits they derive from charitable campaigns, and to maximize the impact of charitable campaigns as campaigns are generally not coordinated and shared with other businesses looking to promote similar charitable causes.

The methods, computer programs and computer systems of the present invention provide businesses and individuals with tools to record, track, and promote charitable donations and charitable campaigns through charitable activity profiles. Businesses may access the computer programs over a network, such as through an Internet web browser or a mobile device application, to set up and organize a charitable campaign, and invite employees or other individuals to contribute their time, money, goods, services, and other donations to the campaign. Individuals may access the computer programs to enter and detail their charitable contributions to a charitable campaign. A weighted score is assigned to each contribution, and the weighted scores for an individual are aggregated to determine a charitable activity score. The individual's charitable activity score, along with the individual contributions, are combined to generate a charitable activity profile for the individual, which may be displayed on a web page associated with the computer programs. The individual thus can see clearly what impact she has on a charitable campaign and determine how they can continue to contribute and maximize their impact. They may also be allowed to see other individual's charitable activity profiles, which may motivate individuals to coordinate charitable efforts and to contribute more, especially if the business organizing a campaign provides rewards for high contribution levels. An individual's contributions are also aggregated with the contributions of other individuals contributing to a campaign, and a weighted score is assigned to the aggregated contributions. The weighted scores are combined to determine a charitable activity score for the business that organized and maintains the campaign. The business's charitable activity score, and aggregated contributions, are combined to generate a charitable activity profile for the business. Individuals and businesses may share their charitable activity profiles through various social media sites to promote and share the campaigns with others. Multiple businesses that maintain charitable giving campaigns may coordinate with each other to effectively maximize their charitable impact on communities.

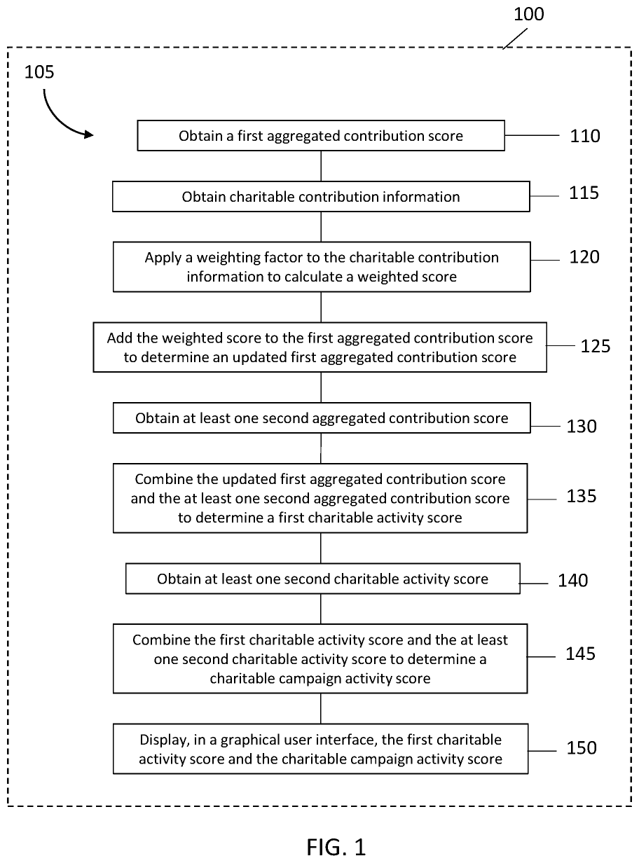

FIG. 1 is a workflow diagram for a computer program 100 configured to carry out a process 105 for generating and updating a charitable activity profile for an individual. As further described below, the computer program 100 may be stored as an application 212 in the memory 210 of a computer system 200 that may be accessed by end-users by various means, such as through an Internet web browser, a mobile device application, and so on. The computer program 100, at block 110, obtains a first aggregated contribution score. As used throughout herein, any “aggregated contribution score” may, in embodiments, be a score of an individual user's contributions of a particular type to a charitable campaign, and may, in exemplary embodiments, be determined as a sum of weighted scores for individual contributions made by that individual that are recorded or tracked through the computer programs and systems described herein. An aggregated contribution score may, for example, reflect an individual user's contributions of money to a charitable campaign. In another example it may reflect an individual user's contributions of goods or services to a charitable campaign. In yet another example it may be a score reflecting an individual's contributions in volunteer time. In embodiments, the first aggregated contribution score may have a non-zero value if an individual user has made contributions and has had those contributions recorded. In embodiments, the first aggregated contribution score may be zero, particularly if the individual has not made a contribution to a charitable campaign or has not recorded a contribution to be score.

At block 115, charitable contribution information is obtained. In exemplary embodiments, charitable contribution information may be obtained via an individual user entering the data relating to a charitable contribution into a user interface, such as a graphical user interface of a software program, a web page on an Internet web site, an application on a mobile device, and so on. The data entered by the user may vary, and in general may include at least one of a type of contribution, an amount of the contribution, and a time of the contribution. The data may also include, for example, the date the contribution was made, where it was made, the charitable campaign the donation was made for, and so on. For example, when recording a donation of goods, the user may enter or select the type of goods that were donated and may also record an amount of goods donated. As another example, when recording time volunteered to a charitable campaign, the user may record the amount of volunteer time spent. The data entered by the user may then be correlated to a corresponding value of that charitable contribution. The correlation may be processed, in one example, via a relational database. For example, the database may correlate the amount of volunteer time entered by the individual user to a monetary value or other similar value that reflects the value of that contribution to the charitable campaign. The corresponding value of the contribution may then be obtained and used as the charitable contribution information. In other examples, charitable contribution information may be entered by a third party on behalf of the individual, may be automatically provided by another computer program or computer system, or may be obtained by other means. The computer program 100 may transmit the information obtained to a database such as database 245, as described further below, to record the information associated with the individual end-user.

At block 120, a weighting factor is assigned to the charitable contribution information to calculate a weighted score for that charitable contribution. The weighting factor may be selected and set by a person or business organizing the charitable campaign, and may be dependent on one or more factors such as the type of contribution made. For example, a particular charitable campaign may be organized to accept contributions of both money and volunteer time, and because the campaign benefits more from employees volunteering their time versus donating money, the organizer may assign a higher weighting factor to time contributions and a lower weighting factor to monetary contributions.

At block 125, the weighted score is added to the first aggregated contribution score to determine an updated first aggregated contribution score. The updated aggregated contribution score may be transmitted to a database 245 and recorded for the individual end-user.

At block 130, the process obtains at least a second aggregated contribution score. The second aggregated contribution score may be an aggregated contribution score for the same individual user that reflects a different type of contribution. For example, one aggregated contribution score for an individual may reflect that person's contributions of goods, and another aggregated contribution score may reflect contributions of volunteer time. Additional aggregated contribution scores may be obtained as well, depending on how many different types of contributions has made. Continuing the previous example, a third aggregated contribution score may reflect the user's contributions of specific goods.

At block 135, the updated first aggregated contribution score and at least the second aggregated contribution score are combined to determine a charitable activity score for the individual user. If there are more than two different aggregated contribution scores for an individual, each of the aggregated contribution scores may be added together to determine the charitable activity score.

At block 140 another charitable activity score is obtained. The first charitable activity score, determined at block 135, may be a charitable activity score for a first individual user, while the other charitable activity score obtained at block 140 may be a second charitable activity score corresponding to a second individual user. The first and second individual users may both be contributors to the same charitable campaign. Additional charitable activity scores, such as charitable activity scores for other individual users contributing to a charitable campaign, may also be obtained at block 140.

At block 145, the first charitable activity score and the second charitable activity score, as well as any additional charitable activity scores, are combined to determine a charitable campaign activity score. The charitable campaign activity score may be an overall score reflecting all recorded contributions to a charitable campaign. The charitable campaign activity score may reflect, for example, all charitable activities and donations made by all individuals to a charitable campaign. The charitable campaign activity score may reflect all charitable donations and activities of all types that have been donated by individuals to the charitable campaign. The charitable campaign activity score may also reflect the total of all aggregated contribution scores across all individuals contributing to a campaign, so that the charitable campaign activity score also reflects all weighted scores of all individual contributions that have been made to the campaign.

Finally, at block 150, the first charitable activity score and the charitable campaign activity score are displayed, such as in a graphical user interface. The display allows an individual user to view his or her own charitable activity score as well as the overall charitable campaign activity score. The display may thus give an individual user a view of how much his or her own individual donations have contributed to the overall charitable campaign. The display of the graphical user interface may also display other information, such as information on other users' donations, records of the individual's discreet contributions as well as individual weighted scores for those discreet contributions, and so on.

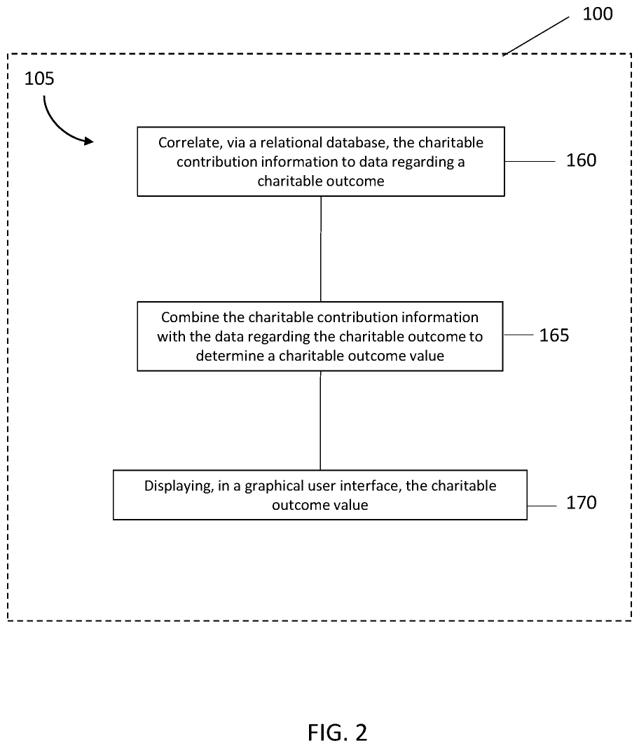

With regard to FIG. 2, in additional embodiments the process 105 of FIG. 1 may include additional steps as described below. The process 105 may include, at block 160, correlating, via a relational database, the charitable contribution information to data regarding a charitable outcome. A “charitable outcome,” as used throughout herein, may be defined as the net or end result of an individual donation or aggregation of donations. For example, individual users contributing to a charitable campaign may make donations of money in order to permit purchase of school supplies for children; the school supplies are a “charitable outcome” as they are the end result of the individual donations and charitable campaign. The term “charitable outcome” may, in examples, be regarded as a “return on charitable activity” or “return on donations,” or a return of some other type, similar to a “return on investment”; that is, it is a net “return” on the individuals' contributions to a charitable campaign.

At block 165, the charitable contribution information is combined with the data regarding the charitable outcome to determine a charitable outcome value. Continuing the example above from block 160, specific data associated with charitable contribution information, such as an amount of money donated, may be combined with the data regarding the charitable outcome, in this example “school supplies,” to determine a total number or school supplies or dollar value of school supplies obtained via the individual's monetary donation, thus determining the value of that charitable outcome.

At block 170, the charitable outcome value is displayed via the graphical user interface. In addition to the information displayed at block 150 in FIG. 1, above, the individual user may have charitable outcome values displayed as well so that the individual may not only see what he or she has contributed but also what those contributions have concretely or tangibly obtained, or what visible effect those contributions have had on a charitable campaign.

It will be appreciated that throughout the description above, an “individual” may not only refer to an actual person but may refer to a business or non-profit entity. It will be further appreciated that throughout the description above, all examples and illustrations are provided by way of example only and not by limitation.

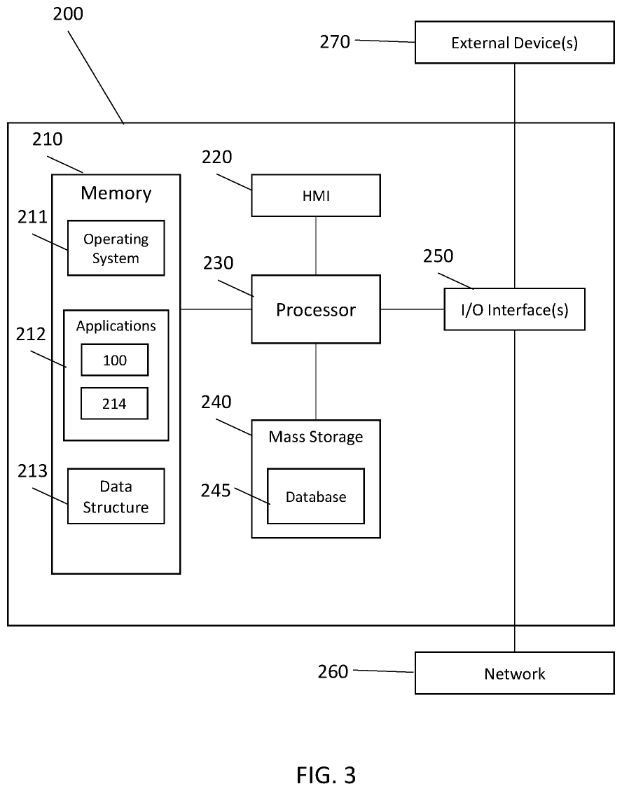

With regard to FIG. 3, any or all the functions and processes as described herein, or a portion thereof, may be implemented via one or more computer programs 100 running on one or more computer systems, such as exemplary computer system 200. The computer system 200 includes a processor 230, a memory 210, a mass storage memory device 240 that includes a database 245, one or more input/output (I/O) interfaces 250 and may include a Human Machine Interface (HMI) 220. The computer system 200, and thus the order fulfillment system, may be operatively coupled to a network 260 and other devices 270, as depicted in FIG. 3, via one or more I/O interfaces 250. The processor 230 includes one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 210. Memory 210 includes a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 240 includes data storage devices such as a hard drive, optical drive, tape drive, volatile or non-volatile solid state device, or any other device capable of storing information. The processor 230 operates under the control of an operating system 211 that resides in memory 210. The operating system 211 manages processing resources so that computer program code embodied as one or more computer software applications, such as applications 212 residing in memory 210, has instructions executed by the processor 230. In an alternative embodiment, the processor 230 executes one or more applications 212 directly, in which case the operating system 211 may be omitted. One or more data structures 213 may also reside in memory 210, and may be used by the processor 230, database 245, operating system 211, or application 212 to store or manipulate data.

The I/O interface 250 provides a machine interface that operatively couples the processor 230 to other devices and systems, such as a network 260 and other external devices 270. Applications 212, which includes data comprising program code for execution by processor 230 to perform the processes described above and depicted in FIG. 1, thereby works by communicating via the I/O interface 250 to provide the various features, functions, applications, processes, or modules comprising embodiments of the invention. The applications 212 may include program code 214 that is executed by, for example, other system or network components 260 external to the computer system 200. Indeed, given the nearly endless hardware and software configurations possible, persons having ordinary skill in the art will understand that embodiments of the invention may include applications that are located externally to the computer system 200, distributed among multiple computers or other external resources, or provided by computing resources (hardware and software) that are provided externally to computer system 200.

The HMI 220, if included, is operatively coupled to the processor 230 of computer system 200 in a known manner to allow a user to interact directly with the computer system 200. The HMI 220 may include video or alphanumeric displays, a touch screen, a speaker, and any other suitable audio and visual indicators capable of providing data to the user. The HMI 220 may also include input devices and controls such as an alphanumeric keyboard, a pointing device, keypads, pushbuttons, control knobs, microphones, etc., capable of accepting commands or input from the user and transmitting the entered input to the processor 230.

A database 245 resides on the mass storage memory device 240 and may be used to collect and organize data used by the various systems and modules described herein. The database 245 may include data and supporting data structures 213, residing in memory 210, that store and organize the data. In particular, the database 245 may be arranged with any database organization or structure including, but not limited to, a relational database, a hierarchical database, a network database, or combinations thereof. A database management system in the form of a computer software application executing as instructions on the processor 230 may be used to access the information or data stored in records of the database 245 in response to a query, where a query may be dynamically determined and executed by the operating system 211, other applications 212, or one or more modules.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining a first aggregated contribution score;
obtaining charitable contribution information;
applying a weighting factor to the charitable contribution information to calculate a weighted score;
adding the weighted score to the first aggregated contribution score to determine an updated first aggregated contribution score;
obtaining at least one second aggregated contribution score;
combining the updated first aggregated contribution score and the at least one second aggregated contribution score to determine a first charitable activity score;
obtaining at least one second charitable activity score;
combining the first charitable activity score and the at least one second charitable activity score to determine a charitable campaign activity score; and,
displaying, in a graphical user interface, the first charitable activity score and the charitable campaign activity score.

2. The method of claim 1 wherein obtaining the charitable contribution information comprises:
obtaining, via the graphical user interface, data regarding a charitable contribution;
correlating, via a relational database, the data regarding the charitable contribution to a corresponding value of the charitable contribution; and,
obtaining the corresponding value of the charitable contribution as the charitable contribution information.

3. The method of claim 2 wherein the data regarding the charitable contribution includes at least one of a type of the contribution, an amount of the contribution, or a time of the contribution.

4. The method of claim 1 wherein the first aggregated contribution score, the at least one second aggregated contribution score, and the first charitable activity score correspond to one individual end-user.

5. The method of claim 4 wherein the at least one second charitable activity score corresponds to a second individual end-user, and wherein c.

6. The method of claim 1 further comprising:
correlating, via a relational database, the charitable contribution information to data regarding a charitable outcome;
combining the charitable contribution information with the data regarding the charitable outcome to determine a charitable outcome value; and,
displaying, in a graphical user interface, the charitable outcome value.

7. A computer program comprising program code to perform a method for generating and updating a charitable activity profile, the method including:
obtaining a first aggregated contribution score;
obtaining charitable contribution information;
applying a weighting factor to the charitable contribution information to calculate a weighted score;
adding the weighted score to the first aggregated contribution score to determine an updated first aggregated contribution score;
obtaining at least one second aggregated contribution score;
combining the updated first aggregated contribution score and the at least one second aggregated contribution score to determine a first charitable activity score;
obtaining at least one second charitable activity score;
combining the first charitable activity score and the at least one second charitable activity score to determine a charitable campaign activity score; and,
displaying, in a graphical user interface, the first charitable activity score and the charitable campaign activity score.

8. The computer program of claim 7 wherein obtaining the charitable contribution information comprises:
obtaining, via the graphical user interface, data regarding a charitable contribution;
correlating, via a relational database, the data regarding the charitable contribution to a corresponding value of the charitable contribution; and,
obtaining the corresponding value of the charitable contribution as the charitable contribution information.

9. The computer program of claim 8 wherein the data regarding the charitable contribution includes at least one of a type of the contribution, an amount of the contribution, or a time of the contribution.

10. The computer program of claim 7 wherein the first aggregated contribution score, the at least one second aggregated contribution score, and the first charitable activity score correspond to one individual end-user.

11. The computer program of claim 10 wherein the at least one second charitable activity score corresponds to a second individual end-user, and wherein the charitable campaign activity score corresponds to an entity in common between the one individual end-user and the second individual end-user.

12. The computer program of claim 7 wherein the method further comprises:
correlating, via a relational database, the charitable contribution information to data regarding a charitable outcome;
combining the charitable contribution information with the data regarding the charitable outcome to determine a charitable outcome value; and,
displaying, in a graphical user interface, the charitable outcome value.

13. A computer system comprising:
a memory;
one or more processors operatively coupled with the memory;
a computer readable storage medium; and,
one or more computer program comprising program code stored on the computer readable storage medium and executable by the one or more processors via the memory to perform a method comprising program code to perform a method, the method comprising:
obtaining a first aggregated contribution score;
obtaining charitable contribution information;
applying a weighting factor to the charitable contribution information to calculate a weighted score;
adding the weighted score to the first aggregated contribution score to determine an updated first aggregated contribution score;
obtaining at least one second aggregated contribution score;
combining the updated first aggregated contribution score and the at least one second aggregated contribution score to determine a first charitable activity score;
obtaining at least one second charitable activity score;
combining the first charitable activity score and the at least one second charitable activity score to determine a charitable campaign activity score; and,
displaying, in a graphical user interface, the first charitable activity score and the charitable campaign activity score.

14. The computer system of claim 13 wherein obtaining the charitable contribution information comprises:
obtaining, via the graphical user interface, data regarding a charitable contribution;
correlating, via a relational database, the data regarding the charitable contribution to a corresponding value of the charitable contribution; and,
obtaining the corresponding value of the charitable contribution as the charitable contribution information.

15. The computer system of claim 14 wherein the data regarding the charitable contribution includes at least one of a type of the contribution, an amount of the contribution, or a time of the contribution.

16. The computer system of claim 13 wherein the first aggregated contribution score, the at least one second aggregated contribution score, and the first charitable activity score correspond to one individual end-user.

17. The computer system of claim 16 wherein the at least one second charitable activity score corresponds to a second individual end-user, and wherein the charitable campaign activity score corresponds to an entity in common between the one individual end-user and the second individual end-user.

18. The computer system of claim 13 wherein the method further comprises:
correlating, via a relational database, the charitable contribution information to data regarding a charitable outcome;
combining the charitable contribution information with the data regarding the charitable outcome to determine a charitable outcome value; and,
displaying, in a graphical user interface, the charitable outcome value.
